(19) United States
(12) Patent Application Publication
(10) Pub. No.: US 2008/0306905 A1
(43) Pub. Date: Dec. 11, 2008

(54) Electronic directory system

(75) Inventors: Donald Charles Clarkson, Edinburg (GB); David William Hunter, Brown Candover (GB); Douglas Matthew Kinloch, Adambrae (GB); Mark Stephen Durrant, Linlithgow (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Numberlink Limited, Edinburgh (GB)

(21) Appl. No.: 12/154,630

(22) Filed: May 22, 2008

Related U.S. Application Data
(60) Provisional application No. 60/933,371, filed on Jun. 5, 2007.

(51) Int. Cl. G06F 7/06; G06F 17/30

(52) U.S. Cl. 707/2; 707/9; 707/E17.017

(57) ABSTRACT

A reverse based Electronic directory system is disclosed in which a subscriber can record a number of individual contact details about themselves, such as their telephone numbers (all types, including business, office direct line, business mobile, VoIP, home, personal mobile, facsimile) and e-mail addresses. The system allows other users to use one of these personal details as a search term in order to obtain other personal details. The system further provides for the ability to set permissions on any detail (such as personal details), so that they are not released without its owner's explicit permission.

The growth of wireless communications over the past two decades has been phenomenal, to the point where mobile telephony is overtaking fixed as the preferred choice of the individual in developed countries.

In developing countries, where there is often no fixed telecoms infrastructure of any significance, wireless telephony is also the preferred solution to keeping apace with the need to communicate.

More recently, the sudden growth of IP telephony, driven by the very low cost of Voice over Internet Protocol (VoIP) calls, particularly when the call is made to an international destination, is causing massive disruption to fixed-network business models.

All these factors are leading to a fixed-mobile convergence for voice communications and whilst it is difficult to imagine the development of fixed telephony over the last century without the assistance of directory services, yet there is no useable directory for the vast array of VoIP numbers (or “user IDs” as they are often known), mobile telephone numbers or e-mail addresses.

It would be desirable, therefore to produce a directory which enables communication and contact between individuals across the globe by linking a person's details in an innovative way which accommodates Data Protection legislation yet protects the individual's privacy to the extent defined by the user.

In a first aspect of the invention there is provided a directory system wherein a user is able to enter two or more of their individual details to said system, said two or more individual details including at least two details that are not the user's name and address, the system being arranged such that, should a search be performed using as a search term one of said at least two details that are not the user's name and address, at least another of said at least two details that are not the user's name and address will be returned as a result of the search.

User's address in the above paragraph refers to a fixed address or postal address, and not to, for example, an e-mail address or other virtual address.

Said at least two details that are not the user's name and address may comprise contact details such as telephone numbers (telephone numbers in this context are to be taken to mean telephone numbers of any kind, whether they be business or personal, fixed line, Voice over Internet Protocol (VOIP-User ID), mobile/cell phone, facsimile, videophone or any other type of telephone number) or e-mail addresses or similar. Said user may also be able to enter their name and any appropriate addresses (including, for example office address, home address), as well as any other individual detail, these details also being usable as a search term. Said system may provide a user with at least one field that is user definable, to enable them to register any detail not provided for in standard fields.

Said system may allow a user to set a permission setting on at least one of their two or more individual details, such that the conditions of the release of that detail are dependent on said permission setting. Preferably, said system allows the setting of a permission by a user for each of their individual details. Said system may allow a user to set one or more details as protected. The system may further be arranged such that any details set as protected are released only with explicit permission from said user. Should such details be returned as a result of a search, said system may be arranged to provide the opportunity for a request to be sent in order to obtain said explicit permission.

Said system may arrange, or allow said user to arrange, said user's at least two or more individual details into categories, wherein the conditions of the release of any detail is dependent on which category that detail is placed in. Said conditions may be such that, should a search be performed using a user's detail from a particular category, the system is arranged to release only other details in that particular category. Should this be the case, the system may also be arranged to inform that other details have been registered and further be operable to provide the opportunity to request from said user any of the user's details from other categories. A user may also be able to set the system such that, should a searched detail be in a particular category, the system will release details from a pre-identified different category, as well as the details in said particular category. Said categories may include a category for individual information that a user is happy to be disclosed to the public, such as a user's employment or business information, and a category for personal individual information. A further category may also be provided which may include a user's information that they have defined as protected. The system may be arranged such that information in this category is released only with explicit permission from said user. Said system may be arranged to provide the opportunity for a request to be sent in order to obtain said explicit permission.

In one embodiment, the system's default permission settings are such that, should the searched detail be in said public category, only details in said category are released, but should the searched detail be found in the personal individual information category, then both the details in the personal individual information and the details in the public category can be released. Equally, the default permission settings may be such that the details in the public category and optionally also the details in the personal individual information category are released should a searched term be in the protected category.

Said system may be arranged to present only a single field for entering a search term, said system being operable to identify if the search term is a telephone number, an e-mail address or text. If the system recognises the search term to be a telephone number, but the telephone number is not in the system's favoured format, said system may be arranged to put said telephone number into said favoured format. Said favoured format may be international format. If the system recognises the search term to be an e-mail address, the system may be arranged to perform a case insensitive search. If the system recognises the search term to be text the system may be arranged to perform an exact match search.

The system may be arranged to accept search terms that are only part of a registered detail, the system being arranged to find all details which contain the search term. In particular the system may be arranged to locate telephone numbers and e-mail addresses when only part of these details are entered as a search term.

Search results may be released in the form of an icon that allows direct communication to the user whose detail has been found.

Said system may allow unregistered users to perform searches, but in such cases, said system may only return limited information. Said limited information may inform the unregistered user that certain information has been found, but that they will need to register first for that information to be released to them.

Said system may be operable to prompt each user to provide a user name, said user name being the only detail that must be unique to each user.

Said system may be web based, a user being able to register and search by accessing the relevant website over the internet. Said system may be arranged to provide a web page for every registered user, each of said web pages being indexable by a search engine. Should such a web page be found by a search engine, the system may be arranged to return only limited information. Said limited information may inform that certain information has been found, but that registration is required for release of said information.

In a further aspect of the invention there is provided a directory system wherein a user is able to enter two or more of their individual details to said system, said system further allowing said user to set a permission setting on at least one of their two or more individual details, the system allowing searches to be performed using any one of said two or more individual details as a search term, the conditions of release of any detail being dependent on that detail's permission setting.

Said conditions of release of a detail may determine whether the system will release an individual detail returned as a result of a search, or whether said user is required to give explicit approval before it is released.

Said two or more details may comprise contact details such as telephone numbers (telephone numbers in this context are to be taken to mean telephone numbers of any kind, whether they be business or personal, fixed line, Voice over Internet Protocol, mobile/cell phone, facsimile, videophone or any other type of telephone number) or e-mail addresses or similar. Said user may also be able to enter their name and address, as well as any other individual detail, these details also being usable as a search term.

Said system may allow the setting of a permission by a user for each of their individual details. Said system may allow a user to set one or more details as protected. The system may further be arranged such that any details set as protected are released only with explicit permission from said user. Should such details be returned as a result of a search, said system may be arranged to provide the opportunity for a request to be sent in order to obtain said explicit permission.

Said system may arrange, or allow said user to arrange, said user's at least two or more individual details into categories, wherein said permission setting is dependent on which category that detail is placed in. Said conditions may be such that, should a search be performed using a user's detail from a particular category, the system is arranged to release only other details in that particular category. Should this be the case, the system may also be arranged to inform that other details have been registered and further be operable to provide the opportunity to request from said user any of the user's details from other categories. A user may also be able to set the system such that, should a searched detail be in a particular category, the system will release details from a pre-identified different category, as well as the details in said particular category. Said categories may include a category for individual information relating to information that a user is happy to be public, such as a user's employment or business information, and a category for personal individual information. A further category may also be provided which may include a user's information that they have defined as protected. The system may be arranged such that information in this category is released only with explicit permission from said user. Said system may be arranged to provide the opportunity for a request to be sent in order to obtain said explicit permission.

In one embodiment, the system's default permission settings are such that, should the searched detail be in said public category, only details in said category are released, but should the searched detail be found in the personal individual information category, then both the details in the personal individual information and the details in the public category can be released. Equally, the default permission settings may be such that both the details in the public category and optionally details in the personal individual information category are released if a searched term is in the protected category.

Said system may provide a user with at least one field that is user definable.

Said system may be arranged to present only a single field for entering a search term, said system being operable to identify if the search term is a telephone number, an e-mail address or text. If the system recognises the search term to be a telephone number, but the telephone number is not in the system's favoured format, said system may be arranged to put said telephone number into said favoured format. Said favoured format may be international format. If the system recognises the search term to be an e-mail address, the system may be arranged to perform a case insensitive search. If the system recognises the search term to be text, the system may be arranged to perform an exact match search.

The system may be arranged to accept search terms that are only part of a registered detail, the system being arranged to find all details which contain the search term. In particular the system may be arranged to locate telephone numbers and e-mail addresses when only part of these details are entered as a search term. Search results may be released in the form of an icon that allows direct communication to the user whose detail has been found.

Said system may allow unregistered users to perform searches, but in such cases, said system may only return limited information. Said limited information may inform the unregistered user that certain information has been found, but that they will need to register for that information to be released to them.

Said system may be web based, a user being able to register and search by accessing the relevant website over the internet. Said system may be arranged to provide a web page for every registered user, each of said web pages being indexable by a search engine. Should such a web page be found by a search engine, the system may be arranged to return only limited information. Said limited information may inform that certain information has been found, but that registration is required for release of said information.

Said system may be arranged such that said two or more individual details include at least two details that are not the user's name and address, the system being arranged such that, should a search be performed using as a search term one of said at least two details that are not the user's name and address, at least another of said at least two details that are not the user's name and address will be returned as a result of the search.

### BRIEF DESCRIPTION OF THE DRAWINGS

Embodiments of the invention will now be described, by way of example only, by reference to the accompanying drawings, in which:

FIG. 1 shows hardware architecture suitable for carrying out the invention;

FIG. 2 shows a diagram of the software architecture from the point of view of a user;

FIG. 3 shows a screenshot which may result when an unregistered or logged out user performs a search;

FIG. 4 shows a screenshot of the registration page;

FIG. 5a and FIG. 5b together shows a flow diagram of the search procedure; and

FIG. 6 shows a diagram of the basic website topography suitable for carrying out the invention

### DETAILED DESCRIPTION OF THE EMBODIMENTS

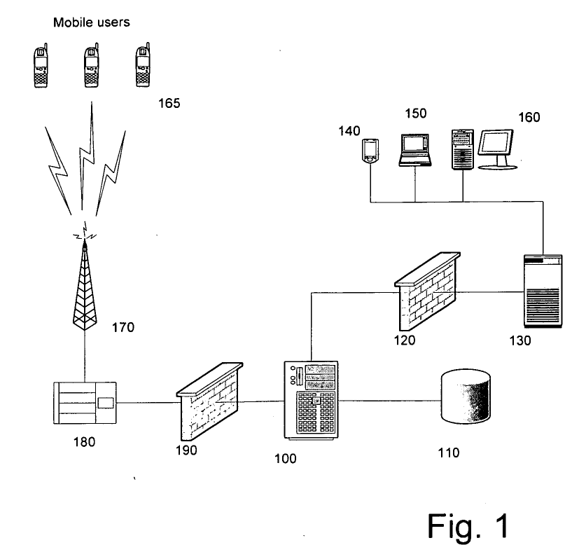

FIG. 1 shows hardware architecture suitable for carrying out the invention. It comprises a main application layer 100 which comprises the code that makes up the rules, registrations and possible searches etc. Connected to this is the main database 110 in which, for example, user details, contacts and permission set-ups are stored. Access to the application layer 100 can be made, via firewall 120 and web server 130, by users on suitable hardware such as handheld computers 140, laptops 150 or home/office personal computers 160. Alternatively the Application layer 100 can be accessed by users on mobile telephone handsets 165, via phone mast 170, or any wireless or fixed network, SMS gateway 180 and firewall 190.

The main functionality of the system allows a user to store a number of pieces of information relevant to them, such that these pieces of information are linked together. Pieces of Information may include two or more of home or business e-mail addresses, telephone numbers, cell phone numbers, Voice over Internet Protocol (VOIP) numbers, work or home addresses, for example. Another user could then obtain one or more pieces of information about the first user, based on a search using a piece of information known to them. For example a second person may only have a cell phone number of a first person, but require their work e-mail address.

By entering the cell phone number in this system and searching, the second person will be able to obtain the first person's work e-mail address. Permissions may be set to allow some information to remain private, or to be accessible only by certain people, or only with explicit permission.

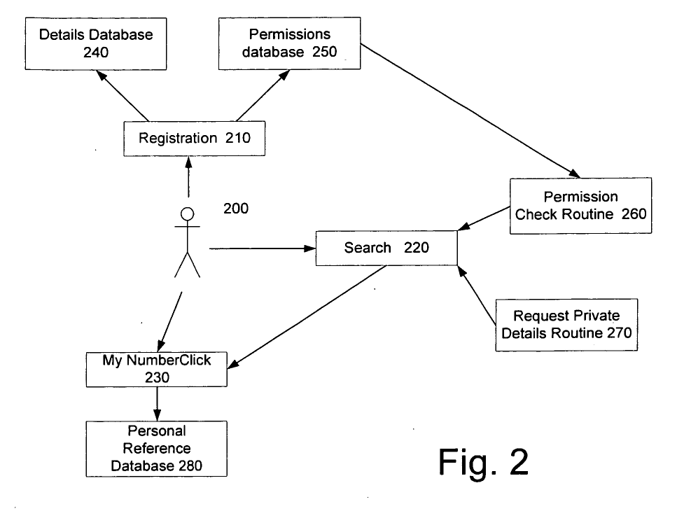

FIG. 2 shows a diagram of the software architecture from the point of view of a user 200. The user has access to three main functionalities, registration 210 (including logging on), searching 220 and their personal list of numbers and contact details contained in the “My Numberclick” page 230. All of these functionalities will be explained in detail below. When accessing the registration functionality 210, a user 200 enters personal details, which are stored in details database 240, and permission details, which are stored in permissions database 250. When making use of the search functionality 220, the system is arranged to run the permission check routine 260 using data stored in the permissions database 250 for each result returned, and where appropriate, run the appropriate routine to request authorisation to release private details 270. Finally, a user accessing their “My Numberclick” page 230 obtains access to their personal reference database 280. As explained below, the search functionality 220 is able to function within the “My Numberclick” page, functionality 230. All databases may be part of database 110, and all routines part of the application layer 100.

In one embodiment the system provides for three main groups of users, although the amount of groups of users may vary: The three main groups are:
Anonymous—users that are not registered to use the system or which are currently not logged in to the system. Those users will have access to website general information, registration form and to search. However, search will have a limited functionality (explained below).
Registered users—users that have completed registration and activation process, and are recognized because they have logged on or have previously selected “remember me” checkbox on login screen. Those users will have access to data search functions, to their personal details, and to a database of their selected records.
Administrators—small number of authorised personnel that will have full access to all features, and will be able to modify or remove other users' records.

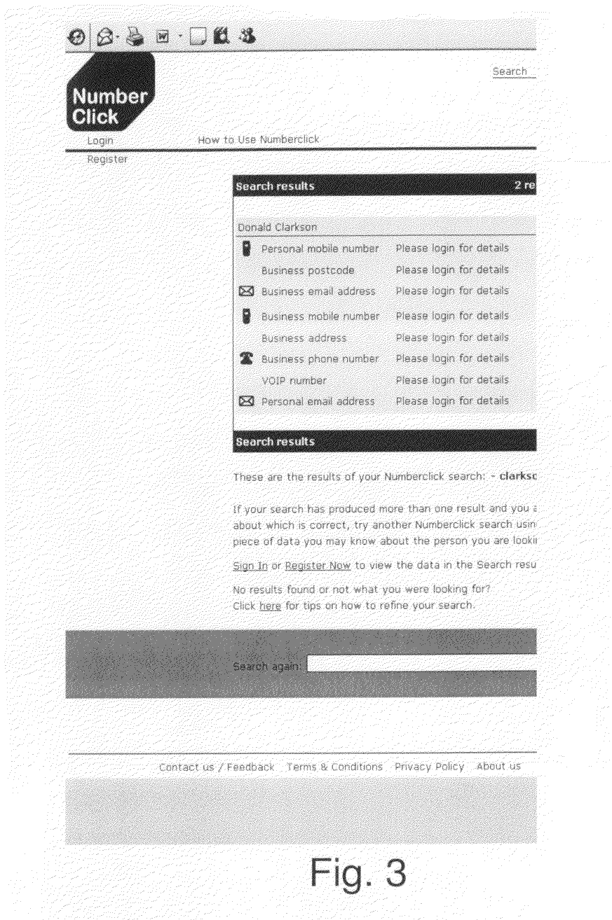

In this embodiment, when anonymous users perform a search, they will receive a message with number of records found, but other relevant details will be withheld prior to registration, a link to registration page being given. For example a screenshot similar to FIG. 3 may result.

Should a user choose to register, they will be prompted to complete a number of personal information fields, this information to be stored into database 110. In one embodiment, fields such as username, password, at least one e-mail address and one mobile phone number will be made mandatory. Other defined fields may be optional but recommended and users will be encouraged to enter them. Those fields will be predefined by system and available on the same screen as mandatory fields.

The system may also provide the possibility to add as many additional user-defined details as the user requires. Those will be in form of two entry boxes instead of one, and users will be able to define both the label (name) of the field and its value.

In a main embodiment, the only unique field will be the username field, which may contain letters and numbers only. However, users will be allowed to use duplicate records if they want.

When registering their details, users will have to identify their primary e-mail address and mobile phone. It will be used for completing the registration process, and in their subsequent communication with this system (for example, forgotten passwords and other messages from system).

International users will be encouraged to enter their name, address, company name and other textual details in both English and their local version. For this reason, additional textual fields will be provided.

Once details are captured and permissions set, user will have to accept Terms and conditions document for site usage. This document may differ based on their country of origin, or generic. After accepting terms and conditions, users will proceed to account activation. In the activation process, the user's e-mail will be used to check for users' identity: Immediately after the user submits their data, they will receive information on how to activate their account, the system sending an mail message to their registered address. This message will ask a user to confirm registration (e.g. “If you are UserX and you wish to confirm registration click here to activate your account.”). When the user clicks on the link, their account will be activated. This mail address will be used as his primary address for subsequent contacts, and for forgotten password retrieval.

Once registered, users will be able to use their username/password to log on to a site to check and amend their details.

A unique aspect of this embodiment of the invention is that, when users enter their details, a “permissions matrix” (table with permissions for linked numbers) for their details will be configured.

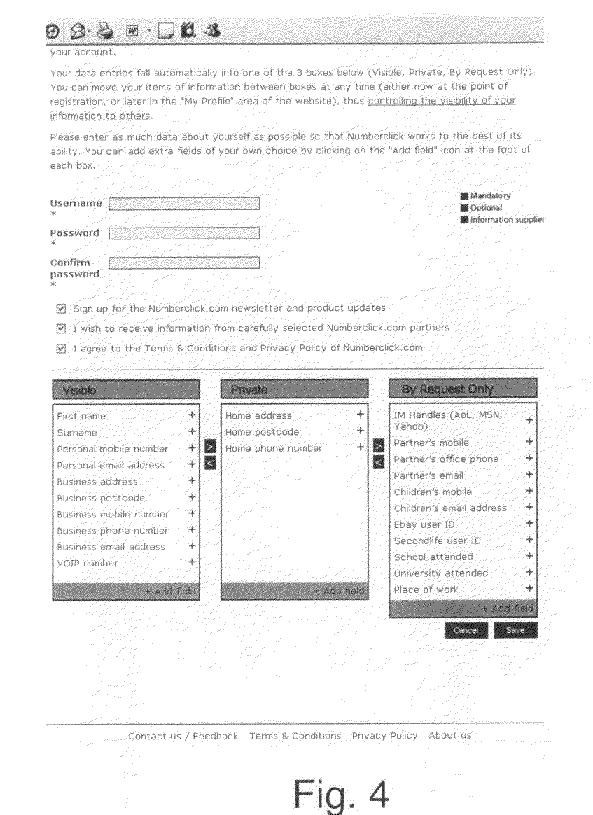

FIG. 4 shows a screen shot which would be presented to a user on registration. In this embodiment, all data entries go by default into one of the 3 available boxes or groups of details (Visible, Private, By Request Only). Users can move the entries between the boxes at any time, either at the point of registration, or later by using the “My Profile” page. Each group may have a number of predefined fields and placeholders for user-defined fields.

For example, if a user's home phone number is published in the conventional phone book and the user is quite happy for it to be visible in this directory also, they can drag it from the “Private” box (where it goes by default) into the “Visible to All” box.

A user's details placed into the “Visible to All” box will be disclosed in the search results should any search (assuming that the person performing the search is registered) match any detail registered by that user, whichever category that search detail is in. Should the search term used also be in the “visible to all” box, only other data in the “Visible to All” box will disclosed in the search result. Everything else will be “grayed out” and not legible. However, the system may provide the option of requesting from the user any of the details not disclosed.

Details placed in the “Private” box, will only be disclosed if the search term used is a detail already in that box. For example, if a user wishes to show their home phone number only to those who they know well, then the Searcher will have had to have searched for it using whatever other contact details you set as “Private” (your address or postcode, for example).

The details in the “By Request Only” box are those which a user only wants disclosed with their specific permission. For example, a friend of a user's daughter has lost her number and uses the Request Detail button to ask the user for it. The choice of whether to grant or decline access is entirely up to the user.

This feature allows a user to guard their sensitive details and to disclose only to named users that request the detail explicitly. If some of the records returned by the system as a result of a search performed by a user have a detail that requires approval, a button or link to start the workflow will be presented. For example, the results page may display a person's business phone number, but in the personal phone number field, the data may appear as “grayed out” with the text “request for approval from J. Smith”

Clicking on request approval link would open a form which will capture a personalized message from requester and send it by, for example, e-mail to John Smith. This mail could contain two buttons—to approve or to reject disclosing of details to requester. If approved, the system will send an e-mail message with requested details to a requester. Equally, this process can also be extended to SMS messaging, with the messaging gateway integrated with the system.

As an alternative to the above, an icon may be presented which, when selected, phones (using VoIP, fixed or mobile networks) the person found directly, either with or possibly without disclosing the number itself.

There may also be provided a permission configuration for advanced users screen. This screen will present a table that will allow users to set granular permissions for each contact detail, by listing exact rules of which details are linked and how. Using the advanced configuration screen will automatically disable permission settings from simple configuration, and users should be warned about this behaviour.

As explained previously, once users have registered, they will be able to perform searches and receive meaningful results. In one embodiment users search the database using only one single search box (although separate search fields may be provided as an alternative). In this embodiment, the system analyzes the entered search string before actual database lookup is performed to try to determine the following: Is the entered string a phone number (for example, only numbers and characters like +( ) are entered), and if so, whether the number is entered in international format. Should an entered phone number not be in international format, the system may be arranged to help users by recognising the originating country.

If, instead, the search string is interpreted as being an e-mail address (possibly by identifying the “@” symbol), the system in this embodiment will make the search case insensitive as e-mail addresses are case insensitive. However, should the search string be identified as ordinary text, the system will not change it in any way, and the search will be performed on an “exact match” basis. This will be done as an attempt to return best possible search results.

FIG. 4 is a flow diagram of the search procedure. At 4010 the search criteria is entered, and at 4020 the system checks whether the user is logged in. If the user is not logged in, limited information is returned 4025, as previously explained, and the user is given the option of logging in 4030. Should they take up this option, the system checks whether the user is registered 4040. If not, the registration procedure is enabled as described 4050. The user is then logged in 4060.

Once when search keyword is entered, the system will perform a search through all searchable fields in the database 4070. If no results are found at 4080, a message is displayed to this effect 4090 and the user is returned to the “enter search criteria” screen 4010. If at least one result is found at 4080, the system then considers whether the number of results is greater than a pre-determined amount “n” 4100. If so, the user is presented with an offer to refine the search 4110, and should they decide to do so, allows the search term to be refined 4120. This will in effect search within the first result set. At any point users will have an opportunity to start their search all over again.

At 4130 each result is checked to see if the matched detail is one of a public (“business” or “visible to all”) detail, a “private” detail or a “protected” (or “by request only”) detail. If found in “public” details, all public (visible to all category) details only are displayed 4140, and a message that private and/or protected details are registered but not being displayed, is shown, as appropriate 4150, 4160. If, at 4130, the detail was one of a “protected” or “private” detail, then both business and private details are displayed 4140, 4170 (alternatively, should the details be in the “private” group then only the private details are returned) and a message that protected details are registered but not being displayed, is shown, if appropriate 4160.

As a result, the user will receive a list of matching records. Each record will have one or more details, depending on permission matrix set by data record owners. Where applicable, a contact detail icon with action may be presented (e.g. phone icon that will load a contact in Skype® or other VOIP tool, an envelope icon that will pop up mail client with pre-populated mail address etc.)

Should there be any registered data not displayed for being “private” or “protected”, then an opportunity may be given to request approval for the private or protected data to be released 4190. This may be done by the user entering a request message 4200, which is then sent to the data “owner” 4210. At 4220, if the “owner” accepts the request, then a message with the requested details will be sent to the user 4230. If the “owner” denies the request (or fails to reply after a pre-determined delay) then a message is sent to the user informing them that their request has been denied 4240

Another optional feature which may be provided is a personal “My Numberclick” page, which is a personal collection of records that a user has selected through searching. Users will be able to manage this collection at any time.

When user performs a search, they will be able to select one or more records that were found and add them to their “My Numberclick” page. It is desirable that the system allows users to add more records at once. For example, should they search by office number and find 5 people that work in the same department of a single company, they may want to add them all in a single procedure and not to have to repeat the procedure 5 times.

Once logged in, users will have a page where they will manage their “My Numberclick” records. They may be able to modify or personalise each record, for example, by adding a nickname to easier recognize a record

“My Numberclick” records may be searchable in different ways. Should a user perform a general search, matched “My Numberclick” records will be identified and separated from the rest of the results. Records that are not in “My Numberclick” will have a checkbox displayed that user can click on to add it to “My Numberclick” directory. It is also possible to perform a search solely limited to the “My Numberclick” data set.

Registered users may be enabled to change any of their personal details at any time. The user interface will be same or similar as for registration, but confirmation and activation will not be needed.

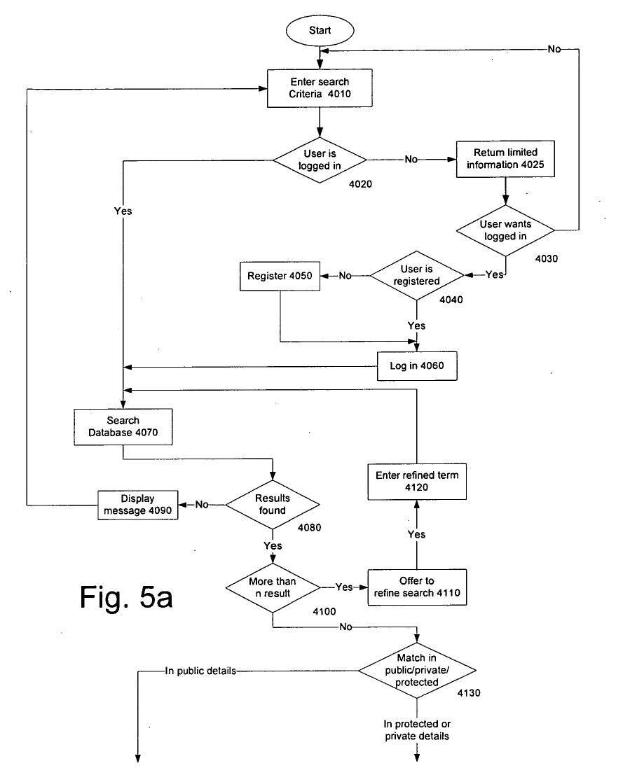

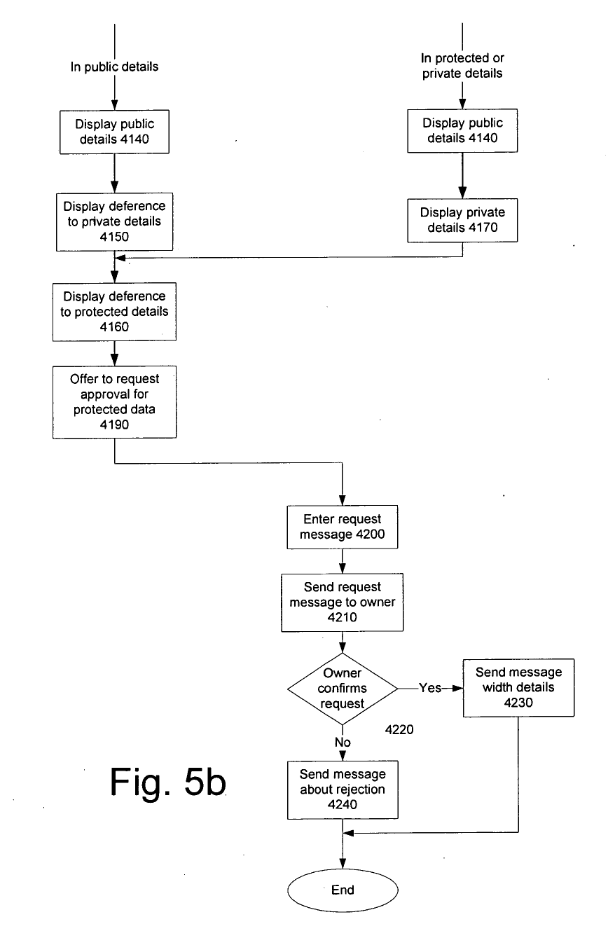

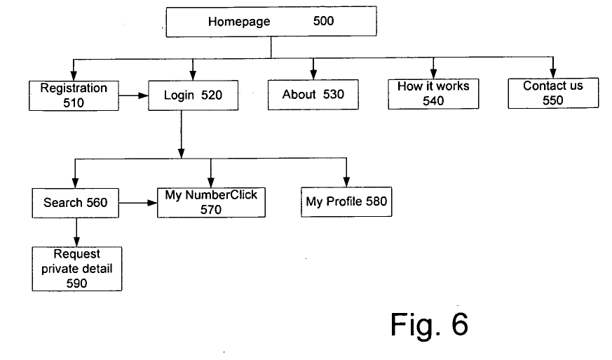

FIG. 5 shows a diagram of the basic website topography suitable for carrying out the invention. At the top layer is the home page 500, below this is Registration 510 and log-in 520, as well as a number of static pages, for example a page informing about the system 530, a page instructing a user how the system works 540, and a “contact us” page 550. Below this is the website main functionality, including the search routines 560, the “My Numberclick” routines, 570 and the user profile 580. Finally, below this is the routine to request permission from a user to release certain information 590.

In one embodiment users may also be able to invite their friends by sending message from the system website. A form for doing this will contain a number of fields to enter a number of e-mail addresses, and an area to enter personalized message. When form is submitted, the system will send a personalized, branded e-mail invitation to every contact, with a link to the system home page or registration form.

Administrators of the system will be able to log onto the system through secure connection (https) to gain access to database management tools and to system statistics.

Database management screens may allow administrators to search for any detail and any record, regardless of permissions settings. Once a record is retrieved, administrators will be able to perform any action on the record, for example
add contact detail;
modify or remove details;
change users' details permissions;
change password;
lock the user out of the system;
make record non-searchable (effectively remove from the system without physical deletion); and/or
send message to user

The system can also be used to compile database statistics, the statistics being created by collecting data and analyzing application usage. This will be done by application itself, and data will be interpreted in relation to the functionality of the site. Reports will be available to site administrators via the same interface as that used to manage the application. Reports available are:
Users count: several metrics—total count, count split by country of origin, new registrations split by day/week/month/year
Anonymous/registered users ratio
Total number of contact details, average number of contact details per person
Users' activity report:
   how many users were active, split by day/week/month/year
   total number of searches, searches split by weeks/month/years
   searches success ratio
Average number of searches per user's session
Searches per data type (name/e-mail/number)
Searches per user type (anonymous/registered)

Web access statistics will not be written into a database, but web server's logs may be used to generate it. Reports may also be created by this tool and may include:
Web page hits
Number of users and visits (sessions)
Originating IP addresses and countries
Referrals
Search phrases for users referred by search engines

In one embodiment, a web page for every system registered user may be created, with a list of all searchable fields set by that particular user. Its look and contents will be similar to search result displayed to anonymous users.

Should those pages be indexed by a search engine, the effect will be that if someone searches for John Smith on that search engine, they will receive the information about his existence on this system.

The above embodiment is for illustration only and other embodiments and variations are envisaged which do not depart from the spirit and scope of the invention. Alternative permission setting arrangements can be envisaged. For example, the system may provide for a simple permission configuration in which data is divided into just two groups of details: Personal details and Business details. In this embodiment, default behaviour may be set to one simple rule: when someone searches by a detail (e.g. number or mail address), all details from the group where searched detail is found are disclosed.

1. A directory system operable such that a user is able to enter two or more of their individual details to said system, said two or more individual details including at least two details that are not the user's name and address, the system being arranged such that, should a search be performed using as a search term one of said at least two details that are not the user's name and address, at least another of said at least two details that are not the user's name and address will be returned as a result of the search.

2. A directory system as claimed in claim 1 wherein said at least two details that are not the user's name and address comprises contact details.

3. A directory system as claimed in claim 2 wherein said contact details comprise telephone numbers of any kind.

4. A directory system as claimed in claim 2 wherein said contact details comprise e-mail addresses.

5. A directory system as claimed in claim 1 wherein said user is able to enter their name and any appropriate addresses as well as any other individual detail, these details also being usable as a search term.

6. A directory system as claimed in claim 1 wherein said system provides a user with at least one field that is user definable, to enable them to register any detail not provided for in standard fields.

7. A directory system as claimed in claim 1 wherein said system allows a user to set a permission setting on at least one of their two or more individual details, such that the conditions of the release of that detail are dependent on said permission setting.

8. A directory system as claimed in claim 7 wherein said system allows the setting of a permission by a user for each of their individual details.

9. A directory system as claimed in claim 1 wherein said system allows a user to set one or more details as protected, the system being arranged such that any details set as protected are released only with explicit permission from said user.

10. A directory system as claimed in claim 9 wherein, should such details that are set as protected be returned as a result of a search, said system is arranged to provide the opportunity for a request to be sent in order to obtain said explicit permission.

11. A directory system as claimed in claim 1 wherein said system arranges, or allow said user to arrange, said user's at least two or more individual details into categories, wherein the conditions of the release of any detail is dependent on which category that detail is placed in.

12. A directory system as claimed in claim 11 wherein said conditions are such that, should a search be performed using a user's detail from a particular category, the system is arranged to release only other details in that particular category.

13. A directory system as claimed in claim 12 wherein the system is further arranged to inform the searcher that other details have been registered and further be operable to provide the opportunity to request from said user any of the user's details from other categories.

14. A directory system as claimed in claim 11 wherein a user is able to set the system such that, should a searched detail be in a particular category, the system will release details from a pre-identified different category, as well as the details in said particular category.

15. A directory system as claimed in claim 11 wherein said categories include a category for individual information that a user is happy to be disclosed to the public, such as a user's employment or business information, and a category for personal individual information.

16. A directory system as claimed in claim 15 wherein a further category is provided which includes a user's information that they have defined as protected, the system being arranged such that information in this category is released only with explicit permission from said user.

17. A directory system as claimed in claim 16 wherein said system is arranged to provide the opportunity for a request to be sent to the user in order to obtain said explicit permission to release information defined as protected.

18. A directory system as claimed in claim 15 wherein the system's default permission settings are such that, should the searched detail be in said public category, only details in said category are released, but should the searched detail be found in the personal individual information category, then both the details in the personal individual information and the details in the public category is released.

19. A directory system as claimed in claim 16 wherein said system is operable such that the default permission settings are such that the details in the public category are released should a searched term be in the protected category.

20. A directory system as claimed in claim 1 wherein said system is arranged to present only a single field for entering a search term, said system being operable to identify if the search term is a telephone number, an e-mail address or text.

21. A directory system as claimed in claim 20 wherein, If the system recognises the search term to be a telephone number, but the telephone number is not in the system's favoured format, said system is arranged to put said telephone number into said favoured format.

22. A directory system as claimed in claim 20 wherein, If the system recognises the search term to be an e-mail address, the system is arranged to perform a case insensitive search.

23. A directory system as claimed in claim 20 wherein, If the system recognises the search term to be text the system is arranged to perform an exact match search.

24. A directory system as claimed in claim 1 wherein said system is arranged to accept search terms that are only part of a registered detail, the system being arranged to find all details which contain the search term.

25. A directory system as claimed in claim 1 wherein search results are released in the form of an icon that allows direct communication to the user whose detail has been found.

26. A directory system as claimed in claim 1 wherein said system allows unregistered users to perform searches, but in such cases, said system only returns limited information.

27. A directory system as claimed in claim 1 wherein said system is operable to prompt each user to provide a user name, said user name being the only detail that must be unique to each user.

28. A directory system as claimed in claim 1 wherein said system is web based, a user being able to register and search by accessing the relevant website over the internet.

29. A directory system as claimed in claim 1 wherein said system is arranged to provide a web page for every registered user, each of said web pages being indexable by a search engine.

30. A directory system as claimed in claim 29 wherein, should such a web page be found by a search engine, the system is arranged to return only limited information.

31. A directory system wherein a user is able to enter two or more of their individual details to said system, said system further allowing said user to set a permission setting on at least one of their two or more individual details, the system allowing searches to be performed using any one of said two or more individual details as a search term, the conditions of release of any detail being dependent on that detail's permission setting.

32. A directory system as claimed in claim 31 wherein said conditions of release of a detail determines whether the system will release an individual detail returned as a result of a search, or whether said user is required to give explicit approval before it is released.

33. A directory system as claimed in claim 31 wherein said two or more details comprises contact details including telephone numbers and e-mail addresses.

34. A directory system as claimed in claim 31 wherein said system arranges, or allow said user to arrange, said user's at least two or more individual details into categories, wherein said permission setting is dependent on which category that detail is placed in.

35. A directory system as claimed in claim 34 wherein said conditions are such that, should a search be performed using a user's detail from a particular category, the system is arranged to release only other details in that particular category.

36. A directory system as claimed in claim 34 wherein should a search be performed using a user's detail, the system is arranged to inform that other details have been registered and further be operable to provide the opportunity to request from said user any of the user's details from other categories, should any of returned details not be releasable due to a conditions setting.

37. A directory system as claimed in claim 34 wherein the system is arranged such that it is settable by a user such that, should a searched detail be in a particular category, the system will release details from a pre-identified different category, as well as the details in said particular category.

38. A directory system as claimed in claim 34 wherein said categories include a category for individual information relating to information that a user is happy to be public, and a category for personal individual information.

39. A directory system as claimed in claim 38 arranged such that information in the personal category is released only with explicit permission from said user.

40. A directory system as claimed in claim 34 wherein a further category is provided which includes a user's information that they have defined as protected.

41. A directory system as claimed in claim 40 wherein, the system is arranged such that information in the protected category is released only with explicit permission from said user.

42. A directory system as claimed in claim 41 wherein said system is arranged to provide the opportunity for a request to be sent in order to obtain said explicit permission.

43. A directory system as claimed in claim 38 wherein the system's default permission settings are such that, should the searched detail be in said public category, only details in said category are released, but should the searched detail be found in the personal individual information category, then both the details in the personal individual information and the details in the public category can be released.

44. A directory system as claimed in claim 38 wherein the default permission settings are such that both the details in the public category are released if a searched term is in the protected category.

45. A directory system as claimed in claim 31 wherein search results are released in the form of an icon that allows direct communication to the user whose detail has been found.

46. A directory system as claimed in claim 31 wherein said system allows unregistered users to perform searches, but in such cases, said system may only return limited information. Said limited information informs the unregistered user that certain information has been found, but that they will need to register for that information to be released to them.

47. A directory system as claimed in claim 31 wherein said system is web based, a user being able to register and search by accessing the relevant website over the internet.

48. A directory system as claimed in claim 31 wherein said system is arranged to provide a web page for every registered user, each of said web pages being indexable by a search engine.

49. A directory system as claimed in claim 48 wherein, should such a web page be found by a search engine, the system is arranged to return only limited information.

50. A directory system as claimed in claim 31 wherein said system is arranged such that said two or more individual details include at least two details that are not the user's name and address, the system being arranged such that, should a search be performed using as a search term one of said at least two details that are not the user's name and address, at least another of said at least two details that are not the user's name and address will be returned as a result of the search.
